(19) United States
(12) Patent Application Publication
(10) Pub. No.: US 2006/0159219 A1
(43) Pub. Date: Jul. 20, 2006

(54) Method for optimizing the search for the optimum protocols for operation of radiological scanners

(75) Inventors: Rainer Kuth, Herzogenaurach (DE); Christoph Zindel, Uttenreuth (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/333,608

(22) Filed: Jan. 17, 2006

(30) Foreign Application Priority Data
Jan. 17, 2005 (DE) 10 2005 002 213.8

(51) Int. Cl. G06F 19/00; H05G 1/60

(52) U.S. Cl. 378/4; 705/3

(57) ABSTRACT

Method for optimizing the search for the optimum protocols for operation of radiological scanners Method for optimizing the search for optimum protocols for operation of radiological scanners, with the protocols used by a plurality of clinical systems being collected in an evaluation center, especially at the device manufacturer, and being arranged in a database in accordance with the underlying clinical tasks, and with maxima of the parameter frequency being sought using a statistical evaluation program.

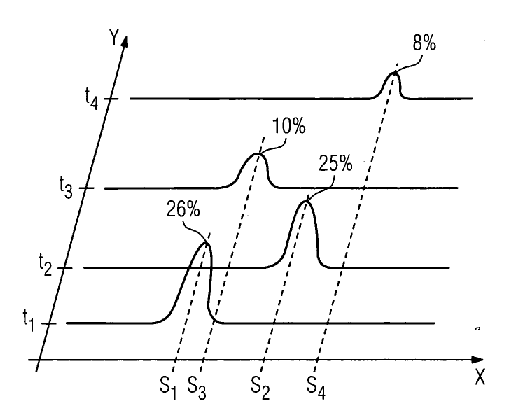

### CROSS REFERENCE TO RELATED APPLICATIONS

This application claims priority to the German application No. 10 2005 002 213.8, filed Jan. 17, 2005 which is incorporated by reference herein in its entirety.

### FIELD OF INVENTION

The invention relates to a method for optimizing the search for a protocol for use with a radiological scanner

### BACKGROUND OF INVENTION

Measurement with MR scanners is controlled by what are referred to as pulse sequences. These are programs which control the equipment of the magnetic resonance scanner in real time, said equipment basically including gradient coils, HF transmitters and data acquisition, optionally characteristics of the receive antennas and/or preamplifiers as well as shim currents for local adjustment of the static magnetic flux.

### SUMMARY OF INVENTION

The type of the pulse sequence and each pulse sequence can be set for modem MR scanners by the operator on the basis of around 30 parameters. Some of the parameters able to be set and their permitted ranges of values depend on each other and can be predetermined by the programmer of the sequence. Depending on the scanner manufacturer the degrees of freedom for parameter settings differ quite markedly for the same sequence types. For a clinical task there are as a rule a number of parameter sets which lead to an at least acceptable result. Thus a large flip angle in combination with a low repetition can deliver the same practical result as a high repetition rate with a small flip angle. Viewed mathematically the parameter space is an approximately 30-dimensional diversity with internal maxima of high diagnostic quality. High diagnostic quality in this case means that the radiologist can make a diagnosis from the images obtained. The requirement for a diagnosis can be a high signal-to-noise ratio of one or more MR images or spectrums. It can however also be a short measurement time per signal, which minimizes blurring, or it can possibly also be a high local resolution. One of the decisive factors for the commercial success of a radiologist or a radiological department of a clinic is that the measurement time per patient at least on average is not too long. No precise value can be specified for this since the reimbursement rates differ depending on the type of insurance that the patient has and for each federal state or region. The costs also differ widely depending on system and type and age.

The same or almost the same clinical-radiological tasks occur again and again within the clinical routine. Therefore a further meta level, known as the protocol level, has been created above the sequence level for which the operator can make settings. A protocol is a data set containing under the name of a sequence all the values which can be set for the approximately 30 parameters.

Different radiologists will use different protocols for the same tasks by chance or as a result of different requirements of their supervisors or different requirements of the health insurance providers or other persons responsible for the matter. The identifying factor of these parameters are that they are not immediately adjacent in the parameter diversity. Each radiologist attempts, for each clinical task, to find the optimum protocol for his or her requirements.

The manufacturers of MR scanners are only aware to some extent of the quality maxima. Manufacturers are very much interested in knowing about all the relevant maxima, since they can then reduce the effort that they put into testing new systems and/or system expansions and the familiarization effort involved for new customers. For radiologists the maxima that they determine themselves are of value in relation to their competitiveness against competing radiologists in the same region. There is practically no competition between regions since patients do not travel very far for reasons of cost, nor would this make any sense because of the similarity of scanners from one range.

Radiologists can also be divided into two groups, these being on the one hand the technical leaders, which is those with the best protocols, and on the other hand the followers, who are radiologists with relatively little experience and little time to try out settings.

Although the manufacturers are attempting to provide the radiologists with standardized protocols, this has generally only met with limited success because of the size of the parameter space.

DE 100 48 422 A1 discloses a method and a device for measuring the clinical effectiveness of diagnostic systems. In this case a method related to a single clinic is used, in which it is established by evaluating all patient files of the clinic which investigation methods for which illnesses have actually led to a decisive diagnosis.

DE 101 36 238 A1 relates to a method for determining the profitability of a medical engineering device. In this case for example it is to be established whether it is worthwhile procuring a further device for an operator or whether replacing an existing device is economically viable. This involves purely financial considerations which relate to a single actual device. Within the context of this method the protocols of the device are also considered.

An object of the invention is to create a method for optimizing the search for optimum protocols for operation of MR scanners which determines the optimum protocol or protocols at relatively low expense for each clinical task, which can thereby be a basis for advising the radiologists.

To achieve this object there is provision in accordance with the invention for the protocols used in each case by a plurality of clinical systems to be collected in an evaluation center, especially at the device manufacturer, and to be arranged in a database in accordance with the underlying clinical tasks, and for maxima of the parameter frequencies to be searched for using a statistical evaluation program.

The approach in accordance with the invention is completely different to that previously adopted, when individual images which were successfully obtained and therefore allowed a good diagnosis and the underlying protocols were namely used to attempt to distill a protocol optimization from the results. Such an image evaluation is extraordinarily expensive and is not a practical option for the inventive task. By contrast the statistical evaluation of the protocols with the aid of a corresponding program and a computer system is possible without any problem even for evaluation of the protocols of thousands of MR systems, with the invention being based on the knowledge that the maxima of the parameter frequency found also actually relates to especially favorable parameter settings. In other words, when a large percentage of several thousand MR system operators use a specific parameter setting for a specific task, it is highly likely to be a guarantee that this is an optimum setting for the clinical task concerned in each case. The frequent trying out and changing of the parameters by the individual system operators means however that clinical tasks are started again and again with incorrect parameter sets. In the statistical maximization and in the fact that a majority of clinics use the same or almost the same parameter settings for a specific clinical task, and that in this way local maxima for the evaluation of the parameter frequency can be detected means that very good access for obtaining optimum protocols is produced.

In a further development of the invention provision can be made for there also to be an investigation during the statistical search for maxima of the parameter frequency as to whether different contrast means lead to different maxima.

Since it is obviously not possible to give a visual presentation of a 30-dimensional diversity, in accordance with a further feature of the present invention there is to be provision for the local maxima of the multi-dimensional parameter space to be presented graphically by just extracting two individual parameters and showing the relative frequency perspectively in the third dimension. This makes sense, since for different tasks the setting of just two specific parameters from the overall parameter space is quite specifically involved and the presentation suggested here very much simplifies the evaluation of the protocols as regards these two main parameters.

Advantageously there can be further provision for the evaluation center to have direct access to the protocol memories of the MR scanners in the clinical systems by being able to dial directly on-line or via an Internet connection into the protocol memory or basically automatically be sent a protocol for each MR investigation.

The evaluation of the protocols can in this case form the basis for consultancy agreements with the clinical system operators covering improving the settings for their devices, with it finally also being within the scope of the invention for the optimum protocol determined for a clinical task to be able to be retrieved by any interested parties via an Internet exchange or such like.

### BRIEF DESCRIPTION OF THE DRAWINGS

Further advantages, features and details of the invention emerge from the description below of the exemplary embodiment as well as with reference to the drawing, which shows a graphical protocol evaluation based on two especially prominent parameters.

### DETAILED DESCRIPTION OF INVENTION

For example the repetition rate is plotted in the direction of the x-axis the layer density in the direction of the y-axis. Based on different layer thicknesses, graphics of the local maxima as a function of repetition time and layer thickness are now produced which are at different layer thickness values for the different repetition times, with for each of these local maxima the value specified also being simultaneously shown (in the form of the height of the zigzag with which this setting has been selected at the different system operators involved). Thus for example for a specific clinical task the MR system was operated by 8% of the operators with the value t₄ of the repetition time and the value S₄ of the layer density, by 10% with the repetition time t₃ and the layer density S₃, by 25% with the repetition time t₂ and the layer density S₂ and finally by 26% with the repetition time t₁ and the layer density S₁.

The invention is not restricted to the exemplary embodiment shown. Thus the two parameter values extracted in each case can obviously relate to entirely different parameters for the graphical presentation and in each case it must always be taken into account that the optimum evaluation with the aid of the inventive evaluation center basically relates to all parameters which can be set, meaning in the optimum case all 30 parameters of an MR system which can be set. The fact that in this case individual of these parameters are relatively non-critical for specific tasks and thus no significant setting difficulties arise here too makes the evaluation somewhat simpler and in particular makes possible the previously discussed simple evaluation with the aid of a graphical presentation.

1.-6. (canceled)

7. A method of optimizing the search for an optimum protocol for operating a radiological scanner, the method comprising:
collecting from a plurality of clinical facilities such protocols used in the respective clinical facility, by an evaluation center, the protocols each having a plurality of protocol parameters;
assigning clinical tasks to the collected protocols;
storing the collected protocols in a database, the database having a structure related to the clinical tasks; and
executing a statistical evaluation program on the collected protocols for detecting maximums of a protocol parameter distribution.

8. The method according to claim 7, wherein executing the statistical evaluation program includes detecting if different maximums are related to different contrast mediums used when operating the respective radiological scanner.

9. The method according to claim 7, wherein the maximums include local maximums of a multidimensional protocol parameter space, the method further comprising graphically representing a local maximum by two individual protocol parameters extracted from the plurality of protocol parameters, the two individual protocol parameters represented by a two-dimensional plane and the local maximum represented in a third dimension relative to the two-dimensional plane such that the resulting graphic is a three-dimensional graphic.

10. The method in accordance with claim 7, wherein collecting the protocols by the evaluation center includes directly accessing a protocol memory of the radiological scanners used in the clinical facilities.

11. The method in accordance with claim 7, further comprising designing a consultancy agreement, the consultancy agreement configured to improve the operation of at least one radiological scanner used in a clinical facility by suggesting an optimized protocol parameter setting of the at least one radiological scanner based on the executed a statistical evaluation program.

12. The method in accordance with claim 7, further comprising designing an optimized protocol for use with at least one radiological scanner based on the executed the statistical evaluation program.

13. The method according to claim 12, further comprising retrieving the optimized protocol from an internet marketplace by a client.
